(19) United States
(12) Patent Application Publication
(10) Pub. No.: US 2026/0175627 A1
(43) Pub. Date: Jun. 25, 2026

(54) HIGH LOAD CAPACITY TIRE COMPRISING A SIDEWALL STIFFENING INSERT

(71) Applicant: COMPAGNIE GENERALE DES ETABLISSEMENTS MICHELIN, Clermont-Ferrand (FR)

(72) Inventors: BENJAMIN VILPERT, Clermont-Ferrand (FR); DOMINIQUE FRAISSE, Clermont-Ferrand (FR)

(21) Appl. No.: 18/854,883

(22) PCT Filed: Mar. 6, 2023
(86) PCT No.: PCT/EP2023/055622

§ 371 Date: Oct. 7, 2024

(30) Foreign Application Priority Data
Apr. 8, 2022 (FR) FR2203235

(51) Int. Cl. B60C 15/00; B60C 11/03; B60C 11/11; B60C 13/00; B60C 15/06

(52) U.S. Cl. CPC B60C 15/0009; B60C 11/0306; B60C 11/11; B60C 13/00; B60C 15/06; B60C 17/0009; B60C 2017/0054; B60C 2017/0063; B60C 2017/0072

(57) ABSTRACT

A high load capacity tire (10) comprises a crown (12), two beads (32), and two sidewalls (30) connecting each bead (32) to the crown (12). The sidewall (30) comprises a sidewall insert (90) comprising an elastomeric composition (92) referred to as rigid and having a modulus at 10% extension that is greater than or equal to 6 MPa, and a maximum thickness (Emax) that is less than or equal to 5.0 mm.

The present invention relates to a tyre. The term “tyre” should be understood to mean a tyre casing intended to form a cavity by cooperating with a support element, for example a rim, this cavity being capable of being pressurized to a pressure greater than atmospheric pressure. A tyre according to the invention has a structure of substantially toroidal shape exhibiting symmetry of revolution about a main axis of the tyre.

The advent of electric or hybrid passenger vehicles is leading to an increase in the weight of the vehicles, notably on account of the batteries, the weight of which is relatively great and substantially proportional to the range (autonomy) of the vehicles. Thus, for example, in order to increase the range of an electric vehicle it is necessary to increase the size of its batteries and, as a result, the weight of the vehicle.

Simply stated, it is currently estimated that one additional kilometre of range of an electric propulsion unit leads to the weight of the vehicle being increased by one kilogram. Thus, in order to achieve a range of 500 kilometres, it is necessary to increase the weight of a vehicle with combustion engine propulsion by approximately 500 kg. Such vehicles need to be fitted with tyres capable of bearing a very high load.

A passenger-vehicle tyre is known from the prior art, this tyre being capable of bearing a relatively high load. This tyre is marketed by MICHELIN™ in their Pilot Sport 4 range and is of size 255/35R18. This tyre offers an EXTRA-LOAD (abbreviated to XL signifying a tyre with an extra load-bearing capacity) version within the meaning of the ETRTO Standards Manual, 2019 and, in this EXTRA-LOAD version, has a load index equal to 94. That means that, at a pressure of 290 kPa, the tyre is capable of bearing a load of 670 kg. This load-bearing capacity is relatively high by comparison with a tyre of the same size and qualified as STANDARD LOAD (abbreviated to SL signifying a tyre with a standard load-bearing capacity) which has a load index equal to 90 and which, for its part, is capable of bearing a load of 600 kg at a pressure of 250 kPa.

For such a tyre to be placed on the market, it must pass regulatory tests. For example, in Europe, the tyre needs to pass the load/speed performance test described at Annex VII to Regulation No. 30 of the Economic Commission for Europe of the United Nations (UN/ECE).

Nonetheless, even in its EXTRA-LOAD version, and all the more so in its STANDARD LOAD version, such a tyre is incapable of bearing the additional load corresponding to the batteries needed to achieve the desired range. Thus, tyre manufacturers have had to offer new solutions in order to meet this new need.

One solution envisaged by tyre manufacturers is, for a given vehicle, the use of tyres of a larger size, which would be able to bear greater load. Thus, a given vehicle could be fitted with tyres having a higher load index. For example, a vehicle fitted with the tyres described above in their EXTRA LOAD version could be fitted with tyres of size 275/35R19 in their EXTRA LOAD version, which have a load index equal to 100 and are capable, at a pressure of 290 kPa, of bearing a load of 800 kg, much greater than the load of 670 kg.

On the one hand, such an increase in tyre size necessarily leads either to a reduction in the amount of vehicle interior space or to an increase in the exterior track width of the vehicle, neither of which is desirable for vehicle habitability and compactness reasons.

On the other hand, such an increase in tyre size necessitates a new vehicle chassis design which, for obvious cost reasons, is not desirable either.

Finally, such an increase in tyre size, notably in nominal section width, leads to an increase in the exterior noise generated by the tyre and to an increase in the rolling resistance, which is not desirable either when wishing to reduce the nuisance noise and the energy consumption of the vehicle.

Thus, another solution the tyre manufacturers have envisioned is, for a given size and a given version of a tyre, to increase the recommended inflation pressure thereof. Specifically, the higher the pressure, the more capable the tyre is of bearing a high load.

Nevertheless, the use of a relatively high recommended pressure increases the stiffness of the tyre and leads to a loss of comfort for the passengers of the vehicle, and this is obviously not desirable to certain motor vehicle manufacturers in instances in which passenger comfort takes priority over the load that can be borne.

Thus, tyre manufacturers have decided to create a new type of tyre. This new type is now known by the denomination “HIGH LOAD CAPACITY” (or High Load) in the ETRTO Standards Manual, 2021. This new type of tyre makes it possible to guarantee that the load that the tyre of a given size is capable of bearing is higher than that which a tyre of the same size, but in its EXTRA LOAD version, would be capable of bearing. For the 255/35R18 size, the tyre of the HIGH LOAD CAPACITY type thus has a load index equal to 98, indicating that it is capable, at a pressure of 290 kPa, of bearing a load of 750 kg.

One problem encountered is connected with the fact that, for the same size, a tyre of the HIGH LOAD CAPACITY type has to bear a relatively high load, this relatively high load leading to a worsening of the handling of the vehicle, notably when the vehicle is yawing.

Thus, the object of the invention is to make a vehicle fitted with tyres of the HIGH LOAD CAPACITY type handle satisfactorily.

To that end, the invention relates to a tyre for a passenger vehicle, comprising a crown, two beads, two sidewalls connecting each bead to the crown, the tyre being of the HIGH LOAD CAPACITY type according to the ETRTO Standards Manual, 2021, the tyre comprising a sidewall insert arranged axially between an exterior surface of at least one of the sidewalls and an interior surface of said sidewall, the sidewall insert comprising at least one elastomeric composition referred to as rigid, the or each rigid elastomeric composition of the sidewall insert having a modulus at 10% extension that is greater than or equal to 6 MPa, the maximum thickness of the rigid elastomeric composition or of the assembly of rigid elastomeric compositions being less than or equal to 5.0 mm.

In order to carry out the invention, the inventors had to understand why the handling obtained was not satisfactory. After many tests, the inventors determined that the sidewalls of the tyre form a flexible portion lying between two rigid portions formed by the crown reinforcement at one end and by each bead at the other.

Thus, in instances in which a significant force is applied to the tyre, notably when the tyre is heavily loaded, the rigid portions formed by the crown reinforcement and by the beads transfer a relatively high proportion of this force to that part of the tyre that has the lowest rigidity or stiffness, in this instance each sidewall. Now, because each sidewall is arranged radially between each bead and the crown, each sidewall bends with a relatively large amplitude of bending, hence the loss of handling performance.

Once the reason for the handling was understood, the inventors behind the invention also had to find a technical solution that would enable a vehicle fitted with tyres of the HIGH LOAD CAPACITY type to be made to handle satisfactorily.

Thus, the inventors discovered that the use of a sidewall insert of relatively high stiffness, in any case greater than the stiffness of the elastomeric compositions usually present in tyre sidewalls, made it possible to reduce the amplitude of the bending in each sidewall. This improved the handling of the vehicle.

Moreover, the use of a sidewall insert according to the invention offers the advantage of offering a better compromise between its cost of manufacture and its effect on handling, unlike other solutions such as, for example, the use of a strengthened carcass reinforcement. Specifically, because the sidewall insert at least partially replaces material already present in the sidewall of the tyre, the cost of manufacture of the tyre according to the invention is not significantly increased by comparison with a tyre that does not have the sidewall insert.

Concerning the modulus at 10% extension, commonly referred to as MA10, this is the elastic modulus of the compound measured during uniaxial tensile testing, at an elongation value of 0.1 (i.e. 10% elongation, expressed as a percentage). The uniaxial tension is applied to the test specimen at a constant rate, and the elongation and the force are measured. The measurement is carried out using a tensile testing machine of the INSTRON@ type, at a temperature of 23° C., and a relative humidity of 50% (to the standard ISO 23529). The conditions for measuring and for exploiting the results in order to determine elongation and stress are as described in the standard NF ISO 37:2012-03. The stress is determined for an elongation of 0.1 and the modulus of elasticity under tension at 10% elongation is calculated as the ratio of this stress value to the elongation value. A person skilled in the art will know how to select and adapt the dimensions of the test specimen according to the quantity of mixture that is accessible and available, in particular in the event that test specimens are taken from the tyre.

The elastomeric composition of the sidewall insert is based on one or several elastomer(s). It may also comprise fillers and other components usually used in the field of compositions for tyres.

The tyre according to the invention is not a tyre suitable for running flat. A tyre suitable for running flat is suitable for running when the pressure in the interior cavity of the tyre is equal to atmospheric pressure (through improper use of language, it is often said that the pressure is zero whereas it is the overpressure with respect to atmospheric pressure that is zero). A tyre suitable for run-flat use comprises self-supporting sidewalls, which is to say ones capable, in the presence of a pressure equal to atmospheric pressure, of bearing the same load, for example, the rated load as indicated in the European Tyre and Rim Technical Organisation (ETRTO) Standards Manual, 2021, which the tyre is capable of bearing when inflated to its usual inflation pressure, for example, its nominal inflation pressure as indicated in the ETRTO Standards Manual, 2021, over a distance greater than or equal to a certain threshold distance at a speed greater than or equal to 80 km/h. A tyre suitable for running flat preferably has a specific marking indicating the ability of the tyre to run flat. Thus, for example, markings in the form of the following acronyms are used, without this list being exhaustive: “ZP” for “Zero Pressure”, “SST” for “Self Supporting Technology”, “SSR” for “Self Supporting Runflat Tyre”, “RF” for “Run Flat”, “RFT” for “Run Flat Tyre”, “EXT” for “EXTended”, “ZP-SR” for “Zero Pressure Short Range” or indeed “ZPS” for “Zero Pressure System”. Another specific marking indicating the ability of the tyre to run flat is the presence of the letter “F” in the tyre size number. Thus, tyres of the size 225/40R18 or 225/40ZR18 are marked 225/40RF18 or 225/40ZRF18 if they are suitable for running flat.

According to the invention, the tyre is for passenger vehicles. Such a tyre is for example defined in the ETRTO (European Tyre and Rim Technical Organisation) Standards Manual, 2021. Such a tyre has, generally on at least one of the sidewalls, a marking conforming to the marking in the ETRTO Standards Manual, 2021 indicating the size of the tyre in the form X/Y α V U β where X denotes the nominal section width, Y denotes the nominal aspect ratio, a denotes the structure and may be R or ZR, V denotes the nominal rim diameter, U denotes the load index and β denotes the speed symbol.

By increasing the load index of the tyre in comparison with the load index of a tyre of the same size in its EXTRA LOAD version, the invention makes it possible to increase the load-bearing capacity of the tyre without thereby modifying the habitability, the compactness and the comfort of the vehicle on which it is used. Specifically, because the size of the tyre of the invention is identical to that of the tyre in its EXTRA LOAD version, the tyre takes up no more space than the tyre in its EXTRA LOAD version. A tyre of the invention may bear distinctive markings so that it can be differentiated from its STANDARD LOAD version and from its EXTRA LOAD version, for example a marking of the HL (HIGH LOAD) or XL+ (EXTRA LOAD+) type. Such markings are notably disclosed in the ETRTO Standards Manual, 2021, on page 3 of the section entitled “General Notes-Passenger Car tyres” for designating tyres of the HIGH LOAD CAPACITY type. Examples of sizes are also disclosed in the ETRTO Standards Manual, 2021, on page 44, paragraph 9.1 in the section “Passenger Car Tyres-Tyres with Metric Designation”.

A tyre of the HIGH LOAD CAPACITY type may be characterized by its load index LI such that LI≥LI′+1, and LI′ being the load index of an EXTRA LOAD tyre of the same size in accordance with the ETRTO Standards Manual, 2021. The load index LI′ is the load index of an EXTRA LOAD tyre of the same size, namely of the same nominal section width, the same nominal aspect ratio, the same structure (R and ZR being considered to be identical) and same nominal rim diameter. The load index LI′ is given in the ETRTO Standards Manual, 2021, notably in the part entitled “Passenger Car Tyres-Tyres with Metric Designation”, pages 22 to 43. LI=LI′+1, or LI=LI′+2, or LI=LI′+3 or else LI=LI′+4, depending on the size. In most embodiments, LI′+1≤LI≤LI′+4, and even LI′+2≤LI≤LI′+4.

The maximum thickness of the rigid elastomeric composition or of the assembly of rigid elastomeric compositions is the maximum value of the thicknesses of the rigid elastomeric composition or of the assembly of rigid elastomeric compositions, the thickness being able to be constant or variable. A thickness of the rigid elastomeric composition or of the assembly of rigid elastomeric compositions is defined, in a meridian section plane, as the thickness of the rigid elastomeric composition or of the assembly of rigid elastomeric compositions at a point of the interior surface of the tyre. The thickness of the rigid elastomeric composition or of the assembly of rigid elastomeric compositions at this point on the interior surface is the straight-line distance along the normal to the interior surface at said point on the interior surface between the radially innermost point of the rigid elastomeric composition or of the assembly of rigid elastomeric compositions and the radially outermost point of the rigid elastomeric composition or of the assembly of rigid elastomeric compositions, these points on the sidewall inserts being aligned along the normal with said point on the interior surface.

The interior surface delimits the interior cavity of the tyre. The interior cavity is intended to be pressurized with the inflation gas once the tyre has been mounted on a mounting support, for example a rim. The interior surface of the sidewall is therefore the part of the sidewall delimiting the interior cavity of the tyre.

The exterior surface is the surface of the tyre in contact with air at atmospheric pressure and visible from the outside of the tyre. The exterior surface of the sidewall is therefore the part of the sidewall in contact with air at atmospheric pressure and visible from the outside of the tyre.

In a preferred embodiment, the or each sidewall insert comprises a rigid elastomeric composition. In certain variants, the or each sidewall insert is constituted by a rigid elastomeric composition. In other variants, the or each sidewall insert comprises a rigid elastomeric composition and one or more elastomeric compositions referred to as flexible, of which the modulus at 10% extension is strictly less than 6 MPa. In these embodiments, the maximum thickness is the thickness of the rigid elastomeric composition.

However, in other embodiments, it may be envisaged that the or each sidewall insert comprises several rigid elastomeric compositions. In these embodiments, the maximum thickness is the maximum thickness of the assembly of rigid elastomeric compositions, i.e., the maximum value of the sum of the thicknesses of each rigid elastomeric composition measured along the same normal to the interior surface of the tyre. In certain variants of these embodiments comprising several rigid elastomeric compositions, all of the elastomeric compositions of the sidewall insert are rigid elastomeric compositions. In other variants of these embodiments comprising several rigid elastomeric compositions, the sidewall insert comprises, in addition to the rigid elastomeric compositions, one or more elastomeric composition(s) referred to as flexible, of which the modulus at 10% extension is strictly less than 6 MPa. In these other variants, the maximum thickness does not take into account the thickness of the or each flexible elastomeric composition, the maximum thickness being defined as the maximum thickness of the assembly of rigid elastomeric compositions.

The tyre according to the invention has a substantially toroidal shape about an axis of revolution substantially coincident with the axis of rotation of the tyre. This axis of revolution defines three directions conventionally used by a person skilled in the art: an axial direction, a circumferential direction and a radial direction.

The expression “axial direction” means the direction substantially parallel to the axis of revolution of the tyre, i.e. the axis of rotation of the tyre.

The expression “circumferential direction” means the direction that is substantially perpendicular both to the axial direction and to a radius of the tyre (in other words, tangent to a circle centred on the axis of rotation of the tyre).

The expression “radial direction” means the direction along a radius of the tyre, that is to say any direction that intersects the axis of rotation of the tyre and is substantially perpendicular to that axis.

The expression “median plane of the tyre” (denoted M) means the plane perpendicular to the axis of rotation of the tyre which is situated axially mid-way between the two beads and passes through the axial middle of the crown reinforcement.

The expression “equatorial circumferential surface of the tyre” means the combination of the planes passing, in each meridian section plane, through the equator (denoted E) of the tyre and perpendicular to the median plane and to the radial direction. The equator of the tyre is, in a meridian section plane (plane perpendicular to the circumferential direction and parallel to the radial and axial directions), the axis parallel to the axis of rotation of the tyre and situated equidistantly between the radially outermost point of the tread that is intended to be in contact with the ground, and the radially innermost point of the tyre that is intended to be in contact with a support, for example a rim, the distance between these two points being equal to H.

The expression “meridian plane” means a plane parallel to and containing the axis of rotation of the tyre and perpendicular to the circumferential direction.

The expressions “radially inner/interior/inside” and “radially outer/exterior/outside” mean closer to the axis of rotation of the tyre and further away from the axis of rotation of the tyre, respectively. The expressions “axially inner/interior/inside” and “axially outer/exterior/outside” mean closer to the median plane of the tyre and further away from the median plane of the tyre, respectively.

A bead means that portion of the tyre that is intended to allow the tyre to be secured to a mounting support, for example a wheel comprising a rim. Thus, each bead is notably intended to be in contact with a flange of the rim allowing it to be attached. Thus, the radially exterior end of the exterior surface of the bead of the tyre is defined as the radially outermost point on the exterior surface of the tyre in contact with a measuring rim of the tyre according to the ETRTO Standards Manual, 2021, when the tyre is inflated to its nominal pressure on this measuring rim.

Any range of values denoted by the expression “between a and b” indicates the range of values extending from more than a to less than b (i.e., endpoints a and b excluded), whereas any range of values denoted by the expression “from a to b” means the range of values extending from a up to b (i.e., including the strict endpoints a and b).

In certain preferred embodiments of the invention, the tyre is intended for passenger vehicles as defined within the meaning of the ETRTO Standards Manual, 2021. Such a tyre has a cross section in a meridian section plane characterized by a section height H and a nominal section width S as defined by the ETRTO Standards Manual, 2021 such that, optionally, the ratio H/S, expressed as a percentage, is at most equal to 90, preferably at most equal to 50 and more preferably at most equal to 40 and is at least equal to 20, preferably at least equal to 25, and the nominal section width S is at least equal to 155 mm, preferably at least equal to 205 mm and more preferably at least equal to 225 mm and at most equal to 385 mm, preferably at most equal to 335. Furthermore, the diameter at the flange D, defining the diameter of the tyre mounting rim, is at least equal to 12 inches, preferably at least equal to 16 inches and at most equal to 24 inches.

In one optional embodiment, each sidewall comprises a sidewall insert arranged axially between the exterior surface of said sidewall and the interior surface of said sidewall, each sidewall insert comprising at least one elastomeric composition referred to as rigid, the or each rigid elastomeric composition of each sidewall insert having a modulus at 10% extension that is greater than or equal to 6 MPa, the maximum thickness of the rigid elastomeric composition or the assembly of rigid elastomeric compositions of each sidewall insert being less than or equal to 5.0 mm.

Thus, in a first variant, there may be two sidewall inserts arranged in the two sidewalls of the tyre, these two sidewall inserts having the same maximum thickness and the same rigid elastomeric composition(s).

In a second variant, there may be two sidewall inserts arranged in the two sidewalls of the tyre, these two sidewall inserts having different maximum thicknesses and/or one or more rigid elastomeric composition(s) having different moduli at 10% extension. In particular, if the tyre has a mounting direction indicating an exterior side and an interior side when mounting it on a vehicle, preference is given to the scenario in which the insert of the sidewall intended to be on the exterior side has a maximum thickness and/or one or more rigid elastomeric composition(s) having a modulus at 10% extension greater than those of the insert of the sidewall intended to be on the interior side.

In advantageous embodiments, the modulus at 10% extension of the or each rigid elastomeric composition is less than or equal to 20 MPa, preferably less than or equal to 15 MPa and more preferentially less than or equal to 13 MPa. Although it improves the handling of the vehicle, too high a stiffness can nevertheless reduce the comfort of the vehicle. Furthermore, excessive stiffness may impair flattening, reducing the surface area of the contact patch. It is therefore preferable to use a sidewall insert that is not excessively stiff.

In advantageous embodiments, the maximum thickness of the rigid elastomeric composition or of the assembly of rigid elastomeric compositions ranges from 1.0 to 5.0 mm, preferably from 1.0 to 3.5 mm and more preferentially from 1.0 to 2.5 mm and more preferentially still from 1.2 to 1.7 mm. Although the stiffness is significantly greater than the stiffnesses of the compositions conventionally used in tyre sidewalls, the greater the maximum thickness, the more the handling of the vehicle is improved. However, beyond a maximum thickness that is too great, the comfort of the vehicle deteriorates, as does the flattening, which leads to a reduction in the surface area of the contact patch.

In other advantageous embodiments, with the or each sidewall having a minimum thickness at a point I, the thickness of the sidewall at a point on the interior surface being defined as the straight-line distance along the normal to the interior surface at said point on the interior surface between said point on the interior surface and a point on the exterior surface of the tyre that is aligned, along the normal, with said point on the interior surface, the point on the interior surface at which the thickness of the rigid elastomeric composition or of the assembly of rigid elastomeric compositions is at a maximum is arranged radially between:
a radially exterior straight line formed by the normal to the interior surface passing through a point on the interior surface arranged 10 mm radially to the outside of the point I,
a radially interior straight line formed by the normal to the interior surface passing through a point on the interior surface arranged 10 mm radially to the inside of the point I.

In other words, the thickness of the rigid elastomeric composition or of the assembly of rigid elastomeric compositions is at a maximum close to the zone in which the sidewall has the smallest thickness. Indeed, for the same stiffness or rigidity, the sidewall bends the most where its thickness is smallest. Therefore, it is advantageous, in order to effectively improve the handling of the vehicle, to stiffen the sidewall in this zone that can potentially experience a high degree of bending.

Optionally, the thickness of the rigid elastomeric composition or of the assembly of rigid elastomeric compositions is at a maximum radially to the outside of the equator of the tyre.

In advantageous embodiments, the radially exterior end of the sidewall insert is arranged radially to the outside of the equator of the tyre.

Advantageously, and optionally, the radially exterior end of the sidewall insert is arranged radially and axially to the inside of a straight line normal to the interior surface and passing through the axially exterior end of the axially widest crown layer of the crown reinforcement.

Indeed, by extending beyond the axially exterior end of the axially widest crown layer, the sidewall insert would needlessly increase the weight and rolling resistance of the tyre.

In some embodiments, the radially exterior end is the radially exterior end of the rigid elastomeric composition or the radially outermost end of the radially exterior ends of the rigid elastomeric compositions of the assembly. In other embodiments, the radially exterior end is the radially outermost end of the radially exterior ends of the rigid or flexible elastomeric compositions of the insert.

In other advantageous embodiments, the radially interior end of the sidewall insert is arranged radially to the inside of the equator of the tyre.

Advantageously, and optionally, the radially interior end of the sidewall insert is arranged radially and axially to the outside of a straight line normal to the interior surface and passing through the radially exterior end of the exterior surface of the bead of the tyre.

Indeed, there is no need for the sidewall insert to extend too far radially inwards, in particular into the bead, because, as indicated in the preamble, this zone of the tyre is already sufficiently rigid. It would therefore just make the tyre needlessly heavier.

In some embodiments, the radially interior end is the radially interior end of the rigid elastomeric composition or the radially innermost end of the radially interior ends of the rigid elastomeric compositions of the assembly. In other embodiments, the radially interior end is the radially innermost end of the radially interior ends of the rigid or flexible elastomeric compositions of the insert.

Optionally, but advantageously, the or each sidewall insert has a cross section in the general shape of a crescent. Thus, the width of the cross section of the sidewall insert is minimal at its radially interior and exterior ends and is maximal between these ends.

Optionally, the tyre comprises a carcass reinforcement comprising at least one carcass layer anchored in the or each bead and extending radially in the or each sidewall and axially in the crown radially to the inside of the crown reinforcement.

Optionally, the or each carcass layer is delimited axially by two axial ends and comprises carcass reinforcing elements extending axially from one axial end to the other of said carcass layer in a main direction that optionally and preferably forms, with the circumferential direction of tyre, an angle, expressed as an absolute value, greater than or equal to 60°, preferably ranging from 80° to 90°.

In certain embodiments, the tyre comprises an inner-liner layer bearing the interior surface of the tyre, the sidewall insert being arranged axially between the inner-liner layer and the axially innermost carcass layer.

In other embodiments, it may be envisaged that the sidewall insert is arranged axially between the axially outermost carcass layer and the exterior surface of the tyre.

In certain variants, the carcass reinforcement comprises a single carcass layer anchored in the or each bead and extending radially in each sidewall and axially in the crown radially to the inside of the crown reinforcement. In these variants, the invention makes it possible, in particular, to avoid adding a second carcass layer or indeed using reinforced carcass reinforcing elements in order to improve the handling of the vehicle. The expression “single carcass layer anchored in the or each bead” means that the carcass reinforcement is, with the exception of the carcass layer, not provided with any layer reinforced with reinforcing elements and anchored in the or each bead. The reinforcing elements of such reinforced layers excluded from the carcass reinforcement of the tyre comprise metal reinforcing elements and textile reinforcing elements. Very preferentially, the carcass reinforcement is made up of the single carcass layer. More preferentially still, the tyre has no sidewall reinforcing layer as defined hereinbelow.

In a first configuration of the carcass reinforcement comprising a single carcass layer, the carcass layer anchored in each bead is wrapped around a circumferential reinforcing element of each bead such that an axially interior portion of the carcass layer anchored in each bead is arranged axially to the inside of an axially exterior portion of the carcass layer anchored in each bead.

In a second configuration of the carcass reinforcement comprising a single carcass layer, each bead comprises an axially interior circumferential reinforcing element arranged axially to the inside of the carcass layer and an axially exterior circumferential reinforcing element arranged axially to the outside of the carcass layer, for example as described in WO 2021/123522.

In other variants, the carcass reinforcement comprises first and second carcass layers anchored in the or each bead and extending radially in each sidewall and axially in the crown radially to the inside of the crown reinforcement, and the sidewall insert is arranged axially to the inside of the first carcass layer. In these other variants, the invention makes it possible, in particular, to avoid the use of a sidewall reinforcing layer or the use of reinforced carcass reinforcing elements in order to improve the handling of the vehicle. At the same time, the performance of the tyre in the regulatory “Breaking Energy Test” is improved as a result of the presence of the two carcass layers in the crown of the tyre.

As described above, it may be envisaged that the sidewall insert is arranged axially to the inside of the axially innermost carcass layer. It may also be envisaged that the sidewall insert is arranged axially between the first carcass layer and the second carcass layer.

In a first configuration of the carcass reinforcement comprising first and second carcass layers, the first carcass layer is wrapped around a circumferential reinforcing element of each bead such that an axially interior portion of the first carcass layer is arranged axially to the inside of an axially exterior portion of the first carcass layer and such that each axial end of the first carcass layer is arranged radially to the outside of each circumferential reinforcing element, and each axial end of the second carcass layer is arranged radially to the inside of each axial end of the first layer.

In a first variant of the first configuration, each axial end of the second carcass layer is arranged axially between the axially interior and exterior portions of the first carcass layer. In this variant, the second carcass layer is arranged radially to the outside of the first carcass layer in the crown.

In a second variant of the first configuration, each axial end of the second carcass layer is arranged axially to the inside of each axially interior portion of the first carcass layer. In this variant, the second carcass layer is arranged radially to the inside of the first carcass layer in the crown and axially to the inside of the first carcass layer in each sidewall.

Such arrangements of the first and second carcass layers in the first and second variants make it possible to obtain effective mechanical coupling between the first and second carcass layers making it possible to reduce shearing between the first and second carcass layers. This then reduces the dissipation of energy and the increase in tyre temperature, especially given that shearing is particularly significant at high load.

Furthermore, thanks to the special arrangement of the first and second carcass layers, a tyre is obtained that surprisingly exhibits optimal energy dissipation and optimal operating temperature in the sidewall, notably at high load and under a pressure lower than or equal to the recommended pressure for a tyre of the same size in its STANDARD LOAD or EXTRA LOAD version. This is all the more surprising given that the particular arrangement of the first and second carcass layers is in a region of the tyre, in this instance in the bead or near the bead, but enables a reduction in the dissipation of energy in another region of the tyre, distant from the bead, in this instance in the sidewall. It has been discovered that the particular arrangement of the carcass reinforcement, namely the fact that each axial end of the second carcass layer is arranged axially between the axially interior and exterior portions of the first carcass layer, or axially to the inside of the axially interior portion of the first carcass layer, makes it possible to reduce the difference in tensions between the first carcass layer and the second carcass layer. Now, the greater the reduction in the difference in tension between the first and second carcass layer, the less shearing is generated between these first and second carcass layers, and the less energy is dissipated.

In a third variant of the first configuration, each axial end of the second carcass layer is arranged axially to the outside of each axially exterior portion of the first carcass layer. In this variant, the second carcass layer is arranged radially to the outside of the first carcass layer in the crown and axially to the outside of the first carcass layer in each sidewall.

This third variant is particularly advantageous for tyres that have relatively tall side walls. Specifically, for tyres of the HIGH LOAD CAPACITY type having a relatively great sidewall height, because the tension in the end of the first carcass layer becomes high, it is preferable to envisage a carcass reinforcement in which, unlike in the arrangement described in the first and second configurations, each axial end of the second carcass layer is arranged axially to the outside of each axially exterior portion of the first carcass layer. With such a carcass reinforcement arrangement, the tension in the end of the first carcass layer will be reduced to a lower level.

In a second configuration of the carcass reinforcement comprising first and second carcass layers, with each bead comprising at least first and second circumferential reinforcing elements, a portion of each first and second carcass layer is arranged axially between two of the at least first and second circumferential reinforcing elements. Such configurations are notably described in WO 2021/123522.

Irrespective of the number of carcass layers in each first configuration, in certain variants, each axial end of the carcass layer or of the first carcass layer is arranged radially to the inside of the equator of the tyre, and more preferentially still, arranged at a radial distance less than or equal to 30 mm from a radially interior end of each circumferential reinforcing element of each bead.

By arranging each axial end of the wrapped carcass layer to the inside of the equator of the tyre, the mass of the carcass reinforcement is significantly reduced. Furthermore, the vast majority of rims currently used for passenger vehicle tyres have J-type rim flanges of which the height is, in all cases, less than 30 mm. The highly preferential arranging of each axial end in a zone substantially radially corresponding to the rim flange enables this axial end to be mechanically protected. Specifically, if each axial end were arranged radially too high above each circumferential reinforcing element of each bead, namely at a radial distance strictly greater than 30 mm from the radially interior end of each circumferential reinforcing element, each axial end would then be situated in a flexible zone of the tyre which zone is subjected to excessively high stresses, which stresses are extremely high in the case of a tyre of HIGH LOAD CAPACITY type.

Irrespective of the number of carcass layers in each first configuration, in other variants, each axial end of the carcass layer or of the first carcass layer is arranged radially to the outside of the equator of the tyre. Advantageously, in these other embodiments, each axial end of the carcass layer or of the first carcass layer is highly preferentially arranged axially to the inside of an axial end of the or of at least one of the crown layer(s) of the crown reinforcement.

In other variants still, the carcass reinforcement comprises a single carcass layer anchored in each bead and extending radially in each sidewall and axially in the crown radially to the inside of the crown reinforcement, the tyre comprising a sidewall reinforcing layer extending at least radially in each sidewall and having:
a radially interior end arranged radially to the inside of the equator of the tyre,
a radially exterior end arranged radially to the outside of the equator of the tyre.

In these other variants still, the invention notably makes it possible to avoid the use of a second carcass layer extending axially in the crown radially to the inside of the crown reinforcement. Thus, the sidewall reinforcing layers are discontinuous under the crown of the tyre.

A sidewall reinforcing layer is not anchored in a bead of the tyre. Thus, the radially interior end of the sidewall reinforcing layer is arranged radially to the outside of the bead.

In some advantageous embodiments, the crown reinforcement comprises a working reinforcement comprising at least one working layer and a hoop reinforcement comprising at least one hooping layer, the hoop reinforcement being arranged radially to the outside of the working reinforcement.

Optionally, the or each hooping layer is delimited axially by two axial ends. The or each hooping layer comprises one or more hoop reinforcing elements wound circumferentially in a helical manner in such a way as to extend axially in a main direction from one axial end to the other of the hooping layer. Optionally and preferably, the main direction forms, with the circumferential direction of the tyre, an angle with an absolute value less than or equal to 10°, preferably less than or equal to 7° and more preferentially less than or equal to 5°.

Optionally, the or each working layer is delimited axially by two axial ends. The or each working layer comprises working reinforcing elements that extend axially from one axial end to the other, substantially parallel to each other in a main direction which optionally and preferably forms, with the circumferential direction of the tyre, an angle with an absolute value that is strictly greater than 10°, preferably between 15° and 50° and more preferentially between 25° and 45°.

As a preference, the or each hoop, working and carcass reinforcing element is a filamentary reinforcing element.

The term “reinforcing element” means an element providing mechanical reinforcement to the polymer matrix in which this reinforcing element is intended to be embedded.

Preferably, each reinforcing element is filamentary, which means to say that each reinforcing element has a length at least 10 times greater than the largest dimension of its cross section, regardless of the shape of the latter: circular, elliptical, oblong, polygonal, in particular rectangular or square or oval. In the case of a rectangular cross section, the filamentary reinforcing element has the shape of a strip.

In optional but advantageous embodiments, the tyre has a sidewall height H defined by H=SW×AR/100 where SW is the nominal section width and AR is the nominal aspect ratio of the tyre, a load index LI satisfying H/LI≥0.85, preferably H/LI≥0.90 where SW, AR and LI are defined in accordance with the ETRTO Standards Manual, 2021. Thus, the invention is preferentially applicable to tyres the handling of which is liable to be impaired on account of the height of their sidewalls. Specifically, the taller the sidewall, the more the sidewall is liable to bend by a relatively significant amount, especially if its load index is high. The invention makes it possible to obtain satisfactory handling for these tyres.

The nominal section width SW and the nominal aspect ratio AR are those from the size marking marked on the sidewall of the tyre and, for example, in accordance with the ETRTO Standards Manual, 2021.

The invention will be understood better from reading the following description, which is given solely by way of non-limiting example and with reference to the drawings, in which:

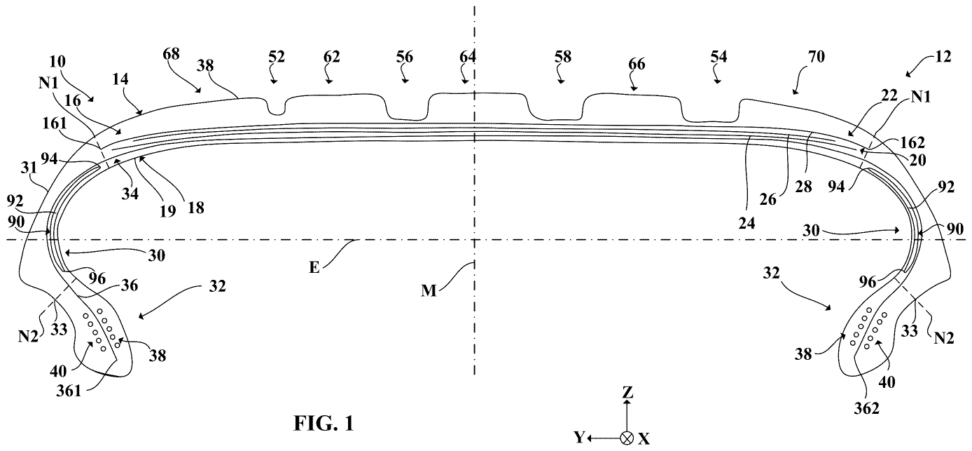

FIG. 1 is a view, in a meridian section plane parallel to the axis of rotation of the tyre, of a tyre according to a first embodiment of the invention,

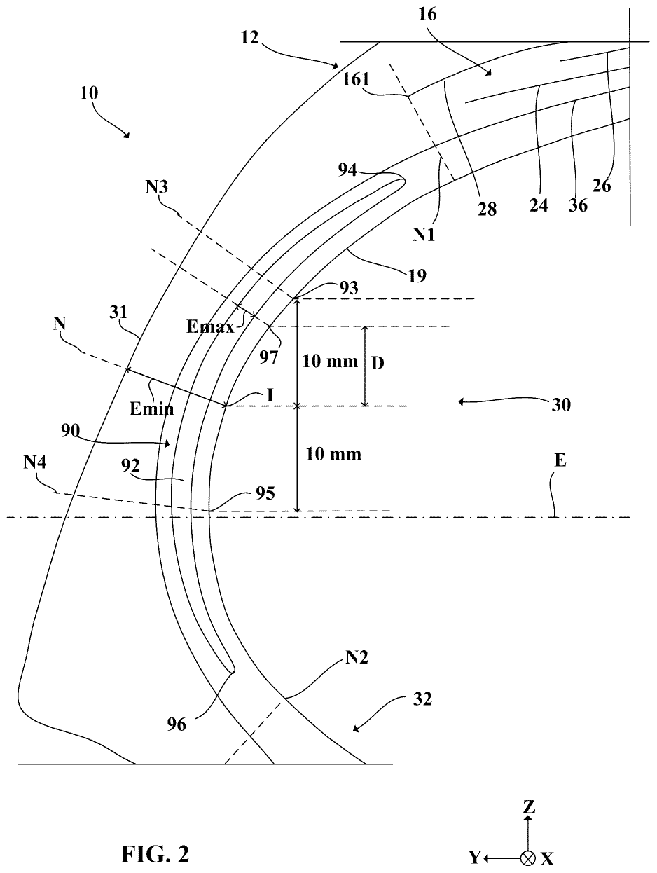

FIG. 2 is a detailed view of one of the sidewalls of the tyre of FIG. 1,

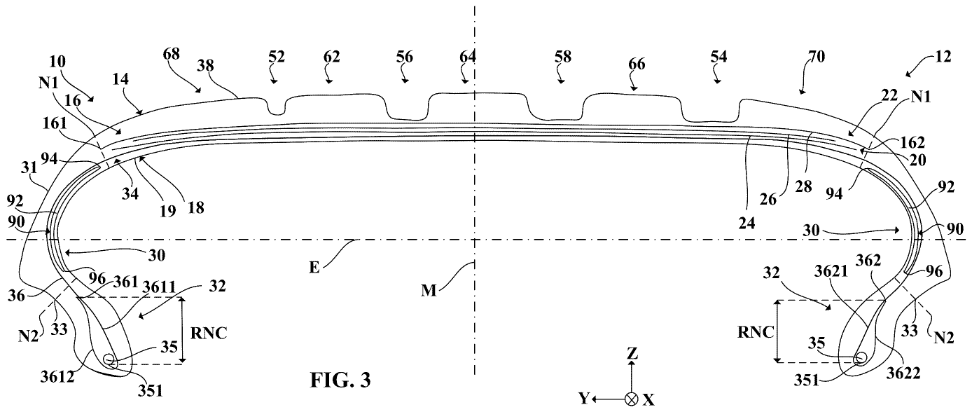

FIGS. 3 to 7 are views similar to that of FIG. 1, of tyres according to second, third, fourth, fifth and sixth embodiments of the invention, respectively, and

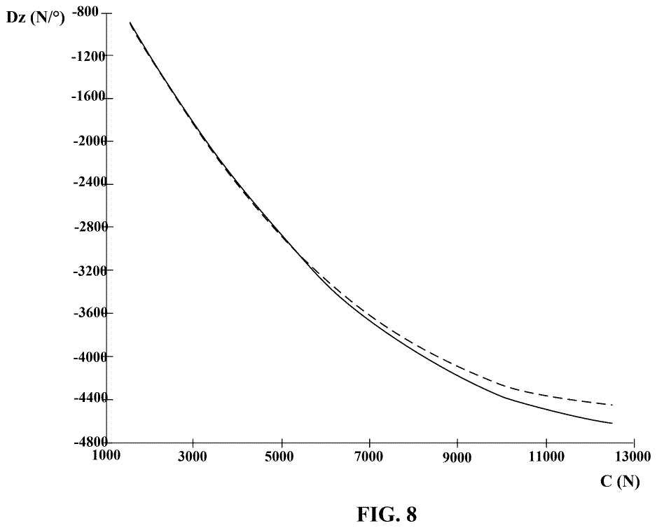

FIG. 8 is a graph illustrating the cornering stiffnesses of the tyre of FIG. 1 and of a control tyre not in accordance with the invention.

A frame of reference X, Y, Z corresponding respectively to the usual axial (Y), radial (Z) and circumferential (X) directions of a tyre is shown in the figures relating to the tyre.

FIG. 1 shows a tyre according to the invention, denoted by the general reference 10. The tyre 10 has a substantially toroidal shape about an axis of revolution substantially parallel to the axial direction Y. The tyre 10 is intended for a passenger vehicle and has dimensions 305/35 R23. In the various figures, the tyre 10 is shown as new, i.e., when it has not yet been run. The tyre 10 has a sidewall height H defined by H=SW×AR/100 where FW is the nominal section width, in this case 305, and AR is the nominal aspect ratio of the tyre, in this case 35, a load index LI in this case equal to 114. Thus, the load index satisfies H/LI≥0.85, preferably H/LI≥0.90, and in this case H/LI=0.94. SW, AR and LI are defined in accordance with the ETRTO Standards Manual, 2021.

The tyre 10 comprises a crown 12 comprising a tread 14 intended to come into contact with the ground when it is running and a crown reinforcement 16 extending in the crown 12 in the circumferential direction X. The tyre 10 also comprises an airtight inner-liner 18 which is impervious to an inflation gas and is intended to delimit, with a support on which the tyre 10 is mounted, an interior cavity once the tyre 10 has been mounted on the mounting support, for example a rim, this cavity being intended to be pressurized by the inflation gas. The inner-liner 18 carries an interior surface 19 of the tyre 10. The tyre 10 also has an exterior surface 31.

The crown reinforcement 16 comprises a working reinforcement 20 and a hoop reinforcement 22, each of these reinforcements 20, 22 comprising at least one crown layer. The working reinforcement 20 comprises at least one working layer and here comprises two working layers comprising a radially interior working layer 24 arranged radially to the inside of a radially exterior working layer 26.

The hoop reinforcement 22 comprises at least one hooping layer and in this instance comprises one hooping layer 28.

The crown reinforcement 16 is arranged radially to the inside of the tread 14. In this instance, the hoop reinforcement 22, in this case the hooping layer 28, is arranged radially to the outside of the working reinforcement 20 and is therefore interposed radially between the working reinforcement 20 and the tread 14.

The tyre 10 comprises two sidewalls 30 that extend the crown 12 radially inwards. The tyre 10 further comprises two beads 32 radially to the inside of the sidewalls 30. Each sidewall 30 connects each bead 32 to the crown 12. Each sidewall 30 bears part of the exterior surface 31 of said sidewall 30.

The tyre 10 comprises a carcass reinforcement 34. The crown reinforcement 16 is arranged radially between the tread 14 and the carcass reinforcement 34. The carcass reinforcement 34 comprises at least one carcass layer 36, in this case a single carcass layer 36, anchored in each bead 32. The carcass layer 36 extends radially in each sidewall 30 and axially in the crown 12, radially to the inside of the crown reinforcement 16.

For the purpose of anchoring the carcass layer 36, the tyre 10 comprises an axially interior circumferential reinforcing element 38 arranged axially to the inside of the carcass layer 36 and an axially exterior circumferential reinforcing element 40 arranged axially to the outside of the carcass layer 36. Here, each reinforcing element 38, 40 comprises a continuous filamentary reinforcing element wound over several circumferential turns, for example as described in WO 2021/123522.

The crown reinforcement 16 comprises two axial ends 161, 162 coinciding here with the ends of the axially widest layer of the crown reinforcement 16.

Each working layer 24, 26, hooping layer 28 and carcass layer 36 comprises a polymeric matrix, in this case elastomeric, in which are embedded one or more reinforcing elements of the corresponding layer, in this case filamentary reinforcing elements. The matrix is said to be polymeric because it is based on a polymeric composition, this polymeric composition possibly comprising one or more polymers, for example selected from thermoplastic polymers, thermosetting polymers, elastomers, thermoplastic elastomers, and also fillers and other components usually used in the field of compositions for tyres, in particular compositions for embedding reinforcing elements.

The hoop reinforcement 22, in this case the hooping layer 28, is axially delimited by two axial ends, in this case the axial ends 161, 162. The hoop reinforcement 22 comprises one or more filamentary hooping reinforcing elements wound circumferentially in a helix so as to extend axially from one axial end of the hooping layer 28 to the other in a main direction D0. The main direction D0 forms, with the circumferential direction X of the tyre 10, an angle AF which, as an absolute value, is less than or equal to 10°, preferably less than or equal to 7°, and more preferably less than or equal to 5°. In this case, AF=−5°.

The radially interior working layer 24 is delimited axially by two axial ends. The radially interior working layer 24 comprises filamentary working reinforcing elements extending axially from one axial end to the other substantially parallel to each other in a main direction D1. Similarly, the radially exterior working layer 26 is delimited axially by two axial ends. The radially exterior working layer 26 comprises filamentary working reinforcing elements extending axially from one axial end to the other substantially parallel to each other in a main direction D2. Each main direction D1, D2 forms, with the circumferential direction X of the tyre 10, respective angles AT1 and AT2 of opposite orientations. Each main direction D1, D2 respectively forms, with the circumferential direction X of the tyre 10, an angle AT1, AT2 which, in terms of absolute value, is strictly greater than 10°, preferably ranging from 15° to 50° and more preferentially ranging from 25° to 45°. In this case, AT1=−33° and AT2=+33°.

The carcass layer 36 is delimited axially by two axial ends 361, 362. The carcass layer 36 comprises filamentary carcass reinforcing elements extending axially from one axial end 361, 362 to the other of the carcass layer 36 in a main direction D3 which, with the circumferential direction X of the tyre 10, forms an angle AC, the absolute value of which is greater than or equal to 60°, preferably ranging from 80° to 90°, and in this case AC=+90°.

Each filamentary hoop reinforcing element, working reinforcing element and carcass reinforcing element is, for example, identical to those described in application WO 2021/123522.

The tread 14 comprises a tread surface 38 via which the tread 14 comes into contact with the ground. The tread 14 comprises several circumferential cuts, here several circumferential grooves, comprising first, second, third and fourth circumferential cuts respectively designated by the references 52, 54, 56, 58.

The tread 14 also comprises several central ribs and here first, second and third central ribs respectively designated by the references 62, 64, 66. Each central rib 62, 64, 66 is arranged axially between two of the adjacent circumferential cuts 52 to 58 and is delimited axially by two adjacent circumferential cuts 52 to 58. The tread 14 also comprises first and second lateral ribs 68, 70.

Even though this is not visible in FIG. 1, each central rib 62, 64, 66 and each lateral rib 68, 70 comprises transverse cuts made in each central rib 62, 64, 66 and each lateral rib 68, 70.

The tyre comprises two sidewall inserts 90. Each sidewall insert 90 is arranged axially between the exterior surface 31 of one of the sidewalls 30 and the interior surface 19 of said sidewall 30. More precisely, each sidewall insert 90 is arranged axially between the airtight inner-liner 18 and the axially innermost carcass layer, in this case the single carcass layer 36. Each sidewall insert 90 has a cross section in the general shape of a crescent.

Each sidewall insert 90 comprises at least one elastomeric composition referred to as rigid. In this case, each sidewall insert 90 comprises a rigid elastomeric composition 92, and in this particular instance consists of a rigid elastomeric composition 92. The rigid elastomeric composition 92 of each sidewall insert 90 has a modulus MA10 at 10% extension that is greater than or equal to 6 MPa and less than or equal to 20 MPa, preferably less than or equal to 15 MPa and more preferentially less than or equal to 13 MPa. In this instance, MA10=8 MPa. In order to formulate this rigid elastomeric composition, it is possible, for example, to use the teaching of WO2014184158, or WO2018111773.

Each sidewall insert 90 comprises a radially exterior end 94 and a radially interior end 96. Each radially exterior end 94 is arranged radially to the outside of the equator E and radially and axially to the inside of a straight line N1 normal to the interior surface 19 and passing through each axially exterior end 161, 162 of the axially widest crown layer of the crown reinforcement 16, in this case the hooping layer 28. Each radially interior end 96 is arranged radially to the inside of the equator E and radially and axially to the outside of a straight line N2 normal to the interior surface 19 and passing through the radially exterior end 33 of the exterior surface 31 of each bead 32.

With reference to FIG. 2, the thickness of the rigid elastomeric composition 92 and therefore, in this case, of the sidewall insert 90, is at a maximum radially to the outside of the equator E. In this instance, the thickness of the rigid elastomeric composition 92 and therefore, in this case, of the sidewall insert 90 is at a maximum between, on the one hand, a radially exterior straight line formed by the normal N3 to the interior surface 19 passing through a point 93 on the interior surface 19 arranged 10 mm radially to the outside of a point I and, on the other hand, a radially interior straight line formed by the normal N4 to the interior surface 19 passing through a point 95 on the interior surface 19 arranged 10 mm radially to the inside of this same point I. The point I is the point on each side wall 30 that exhibits minimum thickness at this point I, the thickness of the sidewall 30 at a point on the interior surface 19 being defined as the straight-line distance along the normal N to the interior surface 19 at this point on the interior surface 19 between this point on the interior surface 19 and a point on the exterior surface of the tyre that is aligned, along the normal N, with this point on the interior surface 19. In this case, the point 97 is the point on the interior surface 19 at which the thickness of the rigid elastomeric composition 92, and therefore in this case of the sidewall insert 90, is at a maximum, this point 97 on the interior surface 19 being arranged radially between the radially exterior straight line N3 and the radially interior straight line N4. The radial distance D between the point I and the point 97 is equal to 7.6 mm.

The maximum thickness Emax of the rigid elastomeric composition 92 and therefore, in this case, of the sidewall insert 90 is less than or equal to 5.0 mm, preferably ranges from 1.0 to 5.0 mm, more preferentially from 1.0 to 3.5 mm and more preferentially still from 1.0 to 2.5 mm, and very preferentially from 1.2 to 1.7 mm. In this case, Emax=1.5 mm and the minimum thickness Emin of each sidewall 30 is such that Emin=6.5 mm.

Tyres according to second, third, fourth, fifth and sixth embodiments of the invention will now be described with reference to FIGS. 3 to 7 respectively, in which figures the elements analogous to those depicted in the preceding figures are designated by the same references.

Unlike the tyre according to the first embodiment, the tyre 10 according to the second embodiment of FIG. 3 is such that the carcass layer 36 anchored in each bead 32 is wrapped around a circumferential reinforcing element 35 of each bead 32, in this case a bead wire, so that an axially interior portion 3611, 3621 of the carcass layer 36 anchored in each bead 32 is arranged axially to the inside of an axially exterior portion 3612, 3622 of the carcass layer 36 anchored in each bead 32 and so that each axial end 361, 362 axially delimiting the carcass layer 36 anchored in each bead 32 is arranged radially to the outside of each circumferential reinforcing element 35. Each axial end 361, 362 of the carcass layer 36 anchored in each bead 32 is arranged radially to the inside of the equator E of the tyre. More precisely, each axial end 361, 362 of the carcass layer 36 anchored in each bead 32 is arranged at a radial distance RNC less than or equal to 30 mm from a radially interior end 351 of each circumferential reinforcing element 33 of each bead 32. In this case, RNC=23 mm.

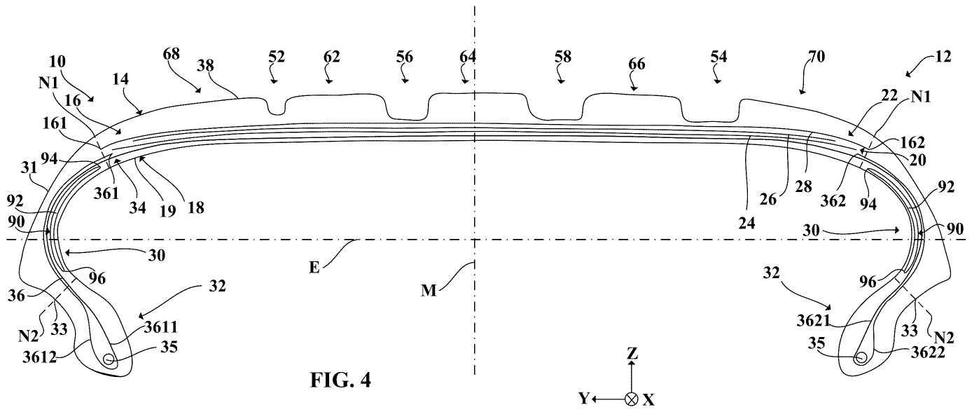

Unlike the tyre according to the second embodiment, the tyre 10 according to the third embodiment of FIG. 4 is such that each axial end 361, 362 of the carcass layer 36 is arranged radially to the outside of the equator E. In this case, each axial end 361, 362 of the carcass layer 36 is highly preferentially arranged axially to the inside of each axial end 161, 162 of the hooping layer 28.

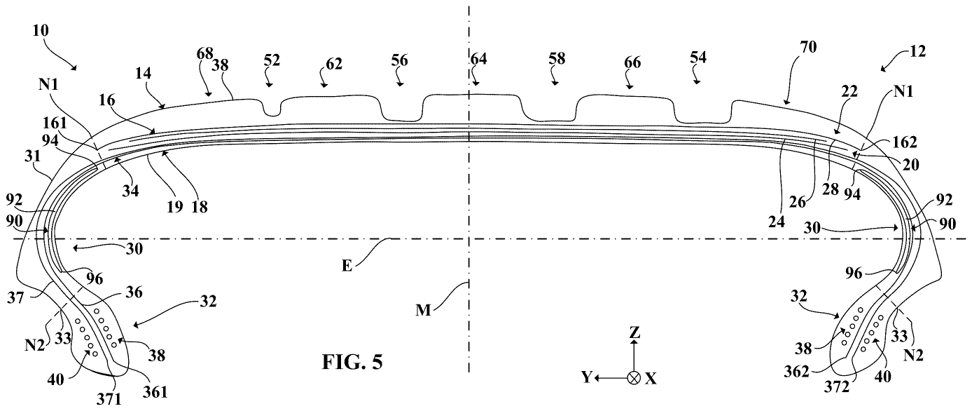

Unlike the tyres according to the preceding embodiments, the carcass reinforcement 34 of the tyre 10 according to the fourth embodiment of FIG. 5 comprises first and second carcass layers 36, 37 anchored in each bead 32 and extending radially in each sidewall 30 and axially in the crown 12 radially to the inside of the crown reinforcement 16. The second carcass layer 37 is arranged axially to the outside of the first carcass layer 36 in each sidewall and radially to the outside of the first carcass layer 37 in the crown 12.

The second carcass layer 37 is delimited axially by two axial ends 371, 372. The second carcass layer 37 comprises filamentary carcass reinforcing elements extending axially from one axial end 371, 372 of the second carcass layer 37 to the other along a main direction D4 which, with the circumferential direction X of the tyre 10, forms an angle AC, which, in absolute value, is greater than or equal to 60°, preferably ranging from 80° to 90° and here AC=+90°.

The sidewall insert 90 is arranged axially to the inside of the first carcass layer 36. A portion of each first and second carcass layer 36, 37 is arranged axially between the circumferential reinforcing elements 38, 40.

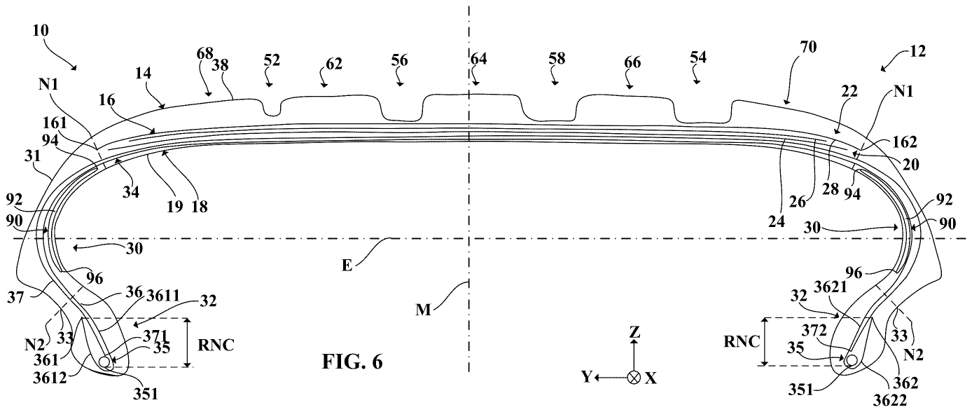

Unlike the tyre according to the fourth embodiment, the tyre 10 according to the fifth embodiment of FIG. 6 is such that the first carcass layer 36 is arranged as in the second embodiment illustrated in FIG. 3. Furthermore, each axial end 371, 372 of the second carcass layer 37 is arranged axially between the axially interior portions 3611, 3621 and axially exterior portions 3612, 3622 of the first carcass layer 36. The second carcass layer 37 is arranged radially to the outside of the first carcass layer 36 in the crown 12.

Other variants of arrangement of the second carcass layer 37 are possible, as was described earlier in the generic description of the present application.

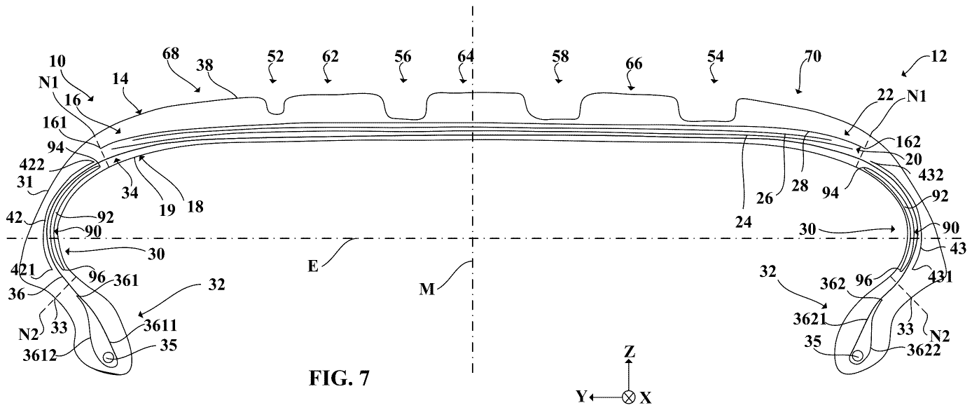

Unlike the first and second embodiments, the tyre 10 according to the sixth embodiment of FIG. 7 comprises two sidewall reinforcing layers 42, 43 extending at least radially in each sidewall 30 and having a radially interior end 421, 431 arranged radially to the inside of the equator E, and a radially exterior end 422, 432 arranged radially to the outside of the equator E. The tyre 10 therefore comprises two sidewall reinforcing layers 42, 43 which are discontinuous under the crown 12.

### Comparative Tests

The tyre 10 according to the first embodiment and in accordance with the invention, and a reference tyre T1 not in accordance with the invention and without a sidewall insert were compared.

The tyres 10 and T1 were tested in order to measure their cornering stiffness and their handling in a subjective test enabling evaluation of the handling of a vehicle fitted with the tyres.

The subjective tests were performed on a circuit by fitting a Range Rover Sport SVR vehicle with the different tyres 10 and T1 on the rear axle. Thus fitted, the load applied to the rear axle was equal to approximately 1576 kg, namely approximately 788 kg per tyre.

Regarding cornering stiffness, FIG. 8 indicates the cornering stiffness Dz, expressed in N/° as a function of the applied load C, expressed in N. The dashed line indicates the variation in the cornering stiffness of the control tyre T1, while the continuous line indicates the variation in the cornering stiffness of the tyre 10. It may be noted that, upwards of a load approximately equal to 5000 N, the tyre 10 according to the invention offers significantly improved cornering stiffness compared to the control tyre T1. Note that the higher the applied load, the greater the improvement in cornering stiffness, particularly at the load applied to each tyre when the tyre is mounted on the vehicle, in this case 7730 N.

Regarding the subjective test, the driver concluded that when the vehicle was fitted with the control tyres T1, the vehicle was unstable in yaw, and its cornering response was highly non-linear. The rear axle was characterized by a lack of thrust, by a long relaxation length and by low yaw damping. The relaxation length is a measure of the time taken for the cornering thrust to build up. When the vehicle was fitted with the tyres 10 according to the invention, the driver concluded that the rear axle felt far stiffer, leading to a short relaxation length.

Thus, the subjective test confirms the improvement to the handling of the vehicle that would have been expected to result from the improvement to the cornering stiffness.

The invention is not limited to the embodiments described above.

1.-12. (canceled)

13. A tire for a passenger vehicle, the tire comprising a crown, two beads, and two sidewalls connecting each bead to the crown,
wherein the tire is a high load capacity tire according to ETRTO Standards Manual, 2021,
wherein the tire further comprises a sidewall insert arranged axially between an exterior surface of at least one of the sidewalls and an interior surface of the at least one of the sidewalls, and
wherein the sidewall insert comprises at least one rigid elastomeric composition, the at least one rigid elastomeric composition of the sidewall insert having a modulus at 10% extension that is greater than or equal to 6 MPa, a maximum thickness of the at least one rigid elastomeric composition being less than or equal to 5.0 mm.

14. The tire according to claim 13, wherein the modulus at 10% extension of the at least one rigid elastomeric composition is less than or equal to 20 MPa.

15. The tire according to claim 13, wherein the maximum thickness of the at least one rigid elastomeric composition ranges from 1.0 to 5.0 mm.

16. The tire according to claim 13, wherein, with each sidewall having a minimum thickness at a point I, a thickness of the sidewall at a point on an interior surface being defined as a straight-line distance along a normal to the interior surface at the point on the interior surface between the point on the interior surface and a point on the exterior surface of the tire that is aligned, along the normal, with the point on the interior surface, the point on the interior surface at which a thickness of the at least one rigid elastomeric composition is at a maximum is arranged radially between:
a radially exterior straight line formed by the normal to the interior surface passing through a point on the interior surface arranged 10 mm radially to an outside of the point I, and
a radially interior straight line formed by the normal to the interior surface passing through a point on the interior surface arranged 10 mm radially to an inside of the point I.

17. The tire according to claim 13, wherein a thickness of the at least one rigid elastomeric composition is at a maximum radially to an outside of an equator of the tire.

18. The tire according to claim 13, wherein a radially exterior end of the sidewall insert is arranged radially to an outside of an equator of the tire.

19. The tire according to claim 13, wherein a radially interior end of the sidewall insert is arranged radially to an inside of an equator of the tire.

20. The tire according to claim 13, further comprising a carcass reinforcement comprising at least one carcass layer anchored in the or each bead and extending radially in the or each sidewall and axially in the crown radially to an inside of the crown reinforcement.

21. The tire according to claim 20, further comprising an inner-liner layer bearing an interior surface of the tire, the sidewall insert being arranged axially between the inner-liner layer and an axially innermost carcass layer.

22. The tire according to claim 20, wherein the carcass reinforcement comprises a single carcass layer anchored in the or each bead and extending radially in each sidewall and axially in the crown radially to an inside of the crown reinforcement.

23. The tire according to claim 20, wherein the carcass reinforcement comprises first and second carcass layers anchored in the or each bead and extending radially in each sidewall and axially in the crown radially to an inside of the crown reinforcement, the sidewall insert being arranged axially to an inside of the first carcass layer.

24. The tire according to claim 13, wherein the or each sidewall has a sidewall height H defined by H=SW×AR/100, where SW is a nominal section width and AR is a nominal aspect ratio of the tire, a load index LI satisfying H/LI≥0.85, where SW, AR and LI are defined in accordance with the ETRTO Standards Manual, 2021.
